(19) United States
(12) Patent Application Publication
(10) Pub. No.: US 2022/0001459 A1
(43) Pub. Date: Jan. 6, 2022

(54) TOOL HOLDER FOR CUTTING INSERT

(71) Applicant: Dae Gyu Kwon, Changwon-si (KR)

(72) Inventors: Dae Gyu Kwon, Changwon-si (KR); Sang Woo Kang, Busan (KR)

(21) Appl. No.: 17/019,355

(22) Filed: Sep. 14, 2020

(30) Foreign Application Priority Data
Jul. 6, 2020 (KR) 1020200082918

(51) Int. Cl. B23B 29/12; B23B 29/06; B23B 29/08

(52) U.S. Cl. CPC B23B 29/12; B23B 29/06; B23B 2205/10; B23B 2205/04; B23B 29/08

(57) ABSTRACT

A tool holder for a cutting insert is proposed, the tool holder being configured to make it possible to easily mount and separate only an insert that is worn during cutting or needs to be replaced for various types of machining, make it possible to easily replace a cutting insert when replacing the cutting insert, and have a coupling structure that enables replacement of even a cutting body on which a cutting insert is mounted.

### CROSS REFERENCE TO RELATED APPLICATION

The present application claims priority to Korean Patent Application No. 10-2020-0082918, filed Jul. 6, 2020, the entire contents of which is incorporated herein for all purposes by this reference.

### BACKGROUND

### Field

The present disclosure relates to a tool holder for mounting a cutting insert and, more particularly, to a tool holder for a cutting insert, the tool holder being configured to make it possible to easily mount and separate only an insert that is worn during cutting or needs to be replaced for various types of machining, make it possible to easily replace a cutting insert when replacing the cutting insert, and have a coupling structure that enables replacement of even a cutting be on which a cutting insert is mounted.

### Description of the Related Art

In general, a lathe, which machines rotating workpieces with cutting tools, can be considered as a representative machine tool that was developed first to usually make it possible to machine the inside or the outside of circular objects.

Recently, it has been developed into an automated CNC lathe and has reached to the level of minimizing consumption of manpower and automatically machining objects with predetermined dimensions by means of software programs. The process of machining a shaft or a pin using such an automated CNC lathe manufactures a product by precisely machining the outer surface of a rod, which is continuously supplied, using cutting tools and then by cutting the rod to a predetermined size with cutting tools.

A cutting insert and a bite that is usually used as a cutting tool of such a lathe and a bite having a bite tip at the end of the shank of a rectangular rod to be simply coupled to a lathe is used as the bite.

Referring to an embodiment of the related art, such a bite is mounted on a fastening block that is fixed to a bed and holds a working position, and the fastening block firmly fixes the bite While holding the working position of the bite by fastening or tightening the bite inserted in the fastening block using a fastening bolt.

The bite receives large load and easily wears when machining workpieces. The fastening block and the bite are integrated by a larger force of a bolt to be supported and easily perform machining.

Accordingly, a lot of trouble such as a large force is required to remove the force and replace the bite When the bite wears. Further, When the machining shape of a workpiece is changed, the hit should be replaced with another bite suitable for the work, but such frequent replacement of bites causes a problem of reduction of a fastening force and deterioration of machining efficiency.

The foregoing is intended merely to aid in the understanding of the background of the present disclosure, and is not intended to mean that the present disclosure falls within the purview of the related art that is already known to those skilled in the art.

### Documents of Related Art

(Patent Document 1) Korean Patent No. 10-1117579: A cutting insert holder using shape memory alloy;

(Patent Document 2) Korean Patent No. 10-1631675: Cutting insert and tool holder or coupling the same.

### SUMMARY

The present disclosure has been made in an effort to solve the problems described above and an objective of the present disclosure is to provide a tool holder for a cutting insert, the tool holder being configured to make it possible to quickly and easily replace only a cutting body that is worn or needs to be replaced for various work processes.

Another objective of the present disclosure is to provide a tool holder for a cutting insert, the tool holder being configured to be assembled in a sliding type and to be easily attached and detached using fastening bolts such that a cutting insert can be positioned at the same machining position as the machining position of a cutting insert on a cutting body before it is replaced.

Another objective of the present disclosure is to provide a tool holder for a cutting insert, the tool holder being configured to increase work efficiency and enable a non-skilled person to easily replace parts by being configured such that a cutting insert can always be fixed with a predetermined protrusive length at an accurate position.

In order to achieve the objectives, according to an embodiment of the present disclosure, a tool holder for a cutting insert includes: a holder body having a predetermined horizontal length and a tool mount disposed on an end portion of the holder body to fix a cutting body combined with a cutting insert at a side of a top of a front thereof, in which the tool mount has a tetrahedral fastening space positioned between a front portion and a rear portion and has a rectangular internal cross-section with open left side and top, a guide hole connected to the fastening space through the front portion, a first bolt hole formed through a right side, and a second bolt hole formed through a center of a front and a center of a rear of the rear portion; and the cutting body has the same shape as a cross-section of the guide hole of the tool mount, is inserted into the fastening space through the guide hole, and has a third bolt hole and a fourth bolt hole formed at positions respectively corresponding to the first bolt hole and the second bolt hole.

According to the tool holder for a cutting insert according to the present disclosure, there is an effect that it is possible to quickly and easily replace a cutting body that is worn or needs to be replaced.

Further, since it is easy to mount and separate a cutting tool on or from a tool mount using a cutting body in an integrated structure of a holder body and the tool mount, even non-skilled people can easily replace various types of cutting tools in accordance with working processes for workpieces even without using a large force.

Further, since a cutting tool can always be fixed with a predetermined length when it is replaced, there is an effect that it is possible to increase work efficiency.

Further, since work is made convenient and machining is performed only with minimum tools and manpower, there is an effect that it is possible to reduce the entire manufacturing cost.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a perspective view of a tool holder for a cutting rt according to an embodiment of the present disclosure;

FIG. 2 is a vertical cross-sectional view of the tool holder for a cutting according to an embodiment of the present disclosure;

FIG. 3 is an exploded perspective view showing the tool holder for a cutting insert according to an embodiment of the present disclosure in one direction;

FIG. 4 is an exploded perspective view showing the tool holder for a cutting insert according to an embodiment of the present disclosure in another direction;

FIG, 5 is a partial exploded perspective view showing the state when a coupler is installed on the assembly of a tool mount and a cutting body of the tool holder for a cutting insert according to an embodiment of the present disclosure;

FIG. 6 is a perspective view showing the tool holder for a cutting insert according to an embodiment of the present disclosure in a state in which an assistant stopper is mounted;

FIG. 7 is an exploded perspective view showing the coupling structure of a tool holder, a cutting body, and an assistant stopper of a holder body of the tool holder for a cutting insert according to an embodiment of the present disclosure;

FIG, 8 is a side view of the tool holder for a cutting insert according to an embodiment of the present disclosure in a state in Which the tool holder, the cutting body, and the assistant stopper of the holder body are combined;

FIG. 9 shows in (a) and (b) cross-sectional views of the tool holder for a cutting insert according to an embodiment of the present disclosure which are respectively (a) taken along line A-A and (b) taken along line B-B in FIG. 8;

FIG. 10 is an exploded perspective view showing a structure for installing a separation guide member in the tool holder for a cutting insert according to an embodiment of the present disclosure in one direction; and

FIG. 11 is a perspective view showing the structure of the separation guide member of the tool holder for a cutting insert according to an embodiment of the present disclosure in one direction.

### DETAILED DESCRIPTION

Hereinbelow, exemplary embodiments of the present disclosure will be described in detail with reference to the accompanying drawings. Throughout the drawings, the same reference numerals will refer to the same or like parts.

An embodiment is described hereafter in detail with reference to the drawings to achieve the objectives.

Although a cutting insert is exemplified as a cutting tool in the following description of an embodiment of the present disclosure, the present disclosure is not limited thereto and any tools, such as a bite, a cutter, and a drill, may be applied as long as they can be mounted and used on a tool holder 10.

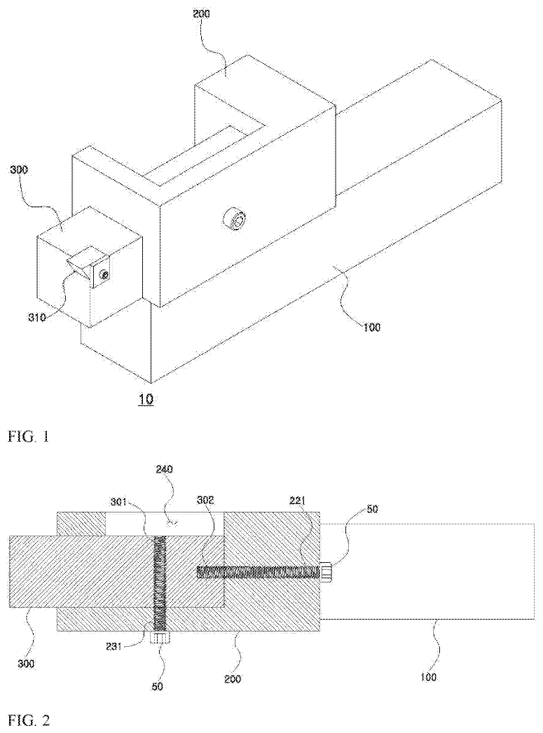

As shown in FIGS. 1 to 4, a tool holder 10 for a cutting insert according to the present disclosure is configured such that a cutting body 300 combined with a cutting insert is easily attached/detached to/from a tool mount 200 and accurate machining adjustment, that is, calibration for a workpiece is possible when the cutting insert is replaced.

In particular, when the cutting body 300 combined with the cutting insert 310 is deformed by shock with the workpiece due to torque or shock by an external force While cutting a workpiece, there is a need for separate work for separating the cutting body 300 from the tool mount 200. Accordingly, the tool holder has the following shape so that the cutting body 300 can be easily separated even under such deformation.

As shown in FIGS. 1 to 4, the tool holder 10 for a cutting insert according to an embodiment of the present disclosure includes: a holder body 100 having a predetermined horizontal length; and a tool mount 200 disposed on an end portion of the holder body 100 and fixing the cutting body 300 combined with a cutting insert 310 at a side of the top of the front.

The tool mount 200 has a tetrahedral fastening space 240 positioned between the front portion 210 and the rear portion 220 and has a rectangular internal cross-section with open left side and top, a guide hole 211 connected to the fastening space through the front portion 210, a first bolt hole 231 formed through the right side 230, and a second bolt hole 221 formed through the center of the front and the center of the rear of the rear portion 220.

The cutting body 300 has the same shape as the cross-section of the guide hole 211 of the tool mount 200 and is inserted into the fastening space 240 through the guide hole 211. Further, the cutting body 300 has a third bolt hole 301 and a fourth bolt hole 302 formed at positions respectively corresponding to the first bolt hole 231 and the second bolt hole 221.

The tool holder 10 for a cutting insert is configured to be always fixed at a predetermined position when it is coupled to a fastening block or a holder that is fixed to a tool post. In detail, the tool holder 10 is composed of the holder body 100 and the tool mount 200 fastening and fixing the cutting body 300 combined with the cutting insert 310.

The holder body 300 has a bar shape having a predetermined length and may have a cuboidal shape that is easily fixed and it would be apparent that the holder body 100 may be changed into a cylindrical shape or other polygonal prism shapes as long as it can be coupled and fixed to the fastening block.

The tool mount 200 is integrally formed at a side of the top of the holder body 100 to fasten and fix the cutting body 300. The tool mount 200 may be configured such that the cutting body 300 can be firmly fixed and the cutting body 300 or the cutting insert 310 on the cutting body 300 is easily attached and detached, if necessary.

Accordingly, the tool mount 200 protrudes upward from the end portion of the holder body 100 and this protrusive structure enables easy attachment/detachment of the cutting body 300 and enables a worker to replace the cutting insert 310 without interference of other structures.

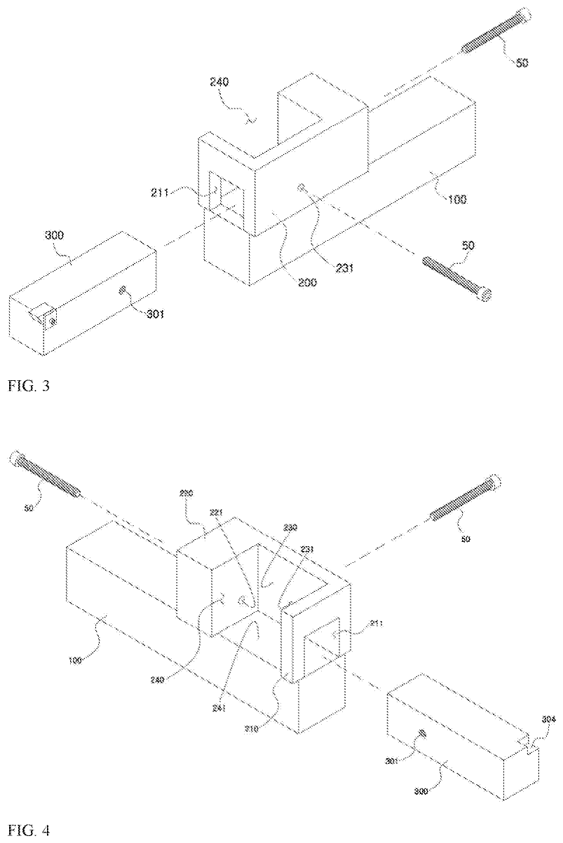

To this end, as shown in FIGS. 3 and 4, the tool mount 200 has a rectangular internal cross-section with open left side and top between the front portion 210 and the rear portion 220 opposite to the front portion 210. That is, the front portion 210 and the rear portion 220 have a tetrahedral damper shape and the tetrahedral fastening space 240 is formed between the front portion 210 and the rear portion 220. The right side 230 connects an edge of the front portion 210 and an edge of the rear portion 220 opposite to the edge of the front portion 210 and closes the right side of the fastening space 240, whereby the fastening space 240 with an open top is formed, A rectangular guide hole 211 is formed through a portion of the front and the rear of the front portion 210 and is connected to the fastening space 240. The first hole 231 is formed through the right side 230 and is connected to the fastening space 240. The second bolt hole 221 is formed through the center of the front and the center of the rear of the rear portion 220 and is connected to the fastening space 240.

As shown in FIGS. 3 and 4, the cutting body 300 has a shape that is the same as the cross-section of the guide hole 211 of the tool mount 200 and is inserted in the fastening space 240 through the guide hole 211 with the front end, to which the cutting insert 310 is coupled, protruding forward from the front portion 210 of the tool mount 200. A coupling groove 302 is formed at a side of the top of the front end exposed forward from the front portion 210 of the tool mount 200 so that the cutting insert 310 is mounted on the cutting body 300, whereby the cutting insert 310 is coupled and. fixed to the coupling groove 304 by a fastener, etc. The third bolt hole 301 and the fourth bolt hole 302 are formed at positions respectively corresponding to the first bolt hole 231 and the second bolt hole 221 of the tool mount 200. The cutting body 300 is firmly fastened, and fixed to the tool mount 200 by tightening fastening bolts 50 respectively in the first bolt hole 231 of the tool mount 200 and the third bolt hole 301 of the cutting body 300, and in the second bolt hole 221 of the tool mount 200 and the fourth bolt hole 302 of the cutting body 300.

The left open side of the fastening space 240 of the tool mount 200 is reinforced and coupling force to the cutting body 300 is increased in the following way.

As shown in FIG. 5, a stepped fitting groove 242 is formed on the bottom 241 of the fastening space 240 of the tool mount 200 and the tool holder 10 further includes a coupler 400 having: a fitting portion 410 having the same shape as the cross-section of the fitting groove 242; and a coupling portion 420 perpendicularly connected to the outer end of the fitting portion 410, having the same height as the height of the cutting body 300, having a protrusive tap 421 having a regular triangular cross-section on the inner side, and having a fifth bolt hole 422 formed therethrough at a position corresponding to the third bolt hole 301.

A close-contact groove 303 having the same shape as the cross-section of the protrusive tap 421 of the coupler 400 is formed on a side of the cutting body 300 to closely accommodate the protrusive tap 421.

The coupler 400 has an integrated structure composed of the fitting portion 410 and the coupling portion 420. The fitting portion 410 has, a horizontal plate shape and is fitted in the stepped fitting groove 242 on the bottom of the fastening space 240 of the tool mount 200, thereby being coupled to the bottom 241 of the fastening space 240 without a step. That is, the fitting portion 410 has the same shape as the cross-section of the fitting groove 242, Whereby they are fitted to each other.

The coupling portion 420 has the protrusive tap 421 on the inner side and the protrusive tap 421 has a regular triangular cross-section, that is, has a shape having a top and a bottom that are symmetrically inclined such that the up-down width gradually decreases toward the end. A fifth bolt hole 422 is formed through the coupling portion 420 to correspond to the position of the third bolt hole 301 of the cutting. body 300 accommodated in the fastening space 420, that is, the fifth bolt hole 422 is formed horizontally through the center of the protrusive tap 421. A side of the cutting body 300 accommodated in the fastening space 240 is aligned with the open side of the fastening space 240 to face the inner side of the coupling portion 420. The close-contact groove 303 having an internal space having the same shape as the cross-section of the protrusive tap 421 is formed on the side of the cutting body 300 that faces the protrusive tap 421 of the coupling portion 420.

Accordingly, after the cutting body 300 is accommodated in the fastening space 240 of the tool mount 200, the fitting portion 410 of the coupler 400 is fitted into the fitting groove 242 of the fastening space 240 and the protrusive tap 421 of the coupling portion 420 of the coupler 400 is closely fitted into the close-contact groove 303 of the cutting body 300. Thereafter, a fastening bolt 50 is tightened into the fifth bolt hole 422 formed through the coupling portion 420 of the coupler 400, the third bolt hole 301 of the cutting body 300, and the first bolt hole 231 of the tool mount 200, thereby firmly fixing the coupler 400, the cutting body 300, and the tool mount 200 to each other.

The tool holder 10 is configured, as follows, to protect the cutting body 300 accommodated in the fastening space 240 of the tool mount 200 from an external force and to have a structure in which the cutting body 300 is mounted on the tool mount 200 in close contact with the fastening space 240.

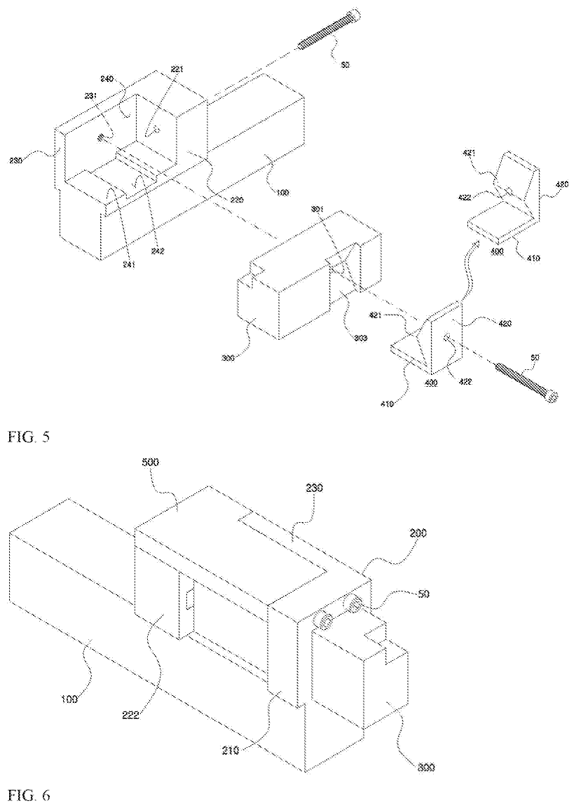

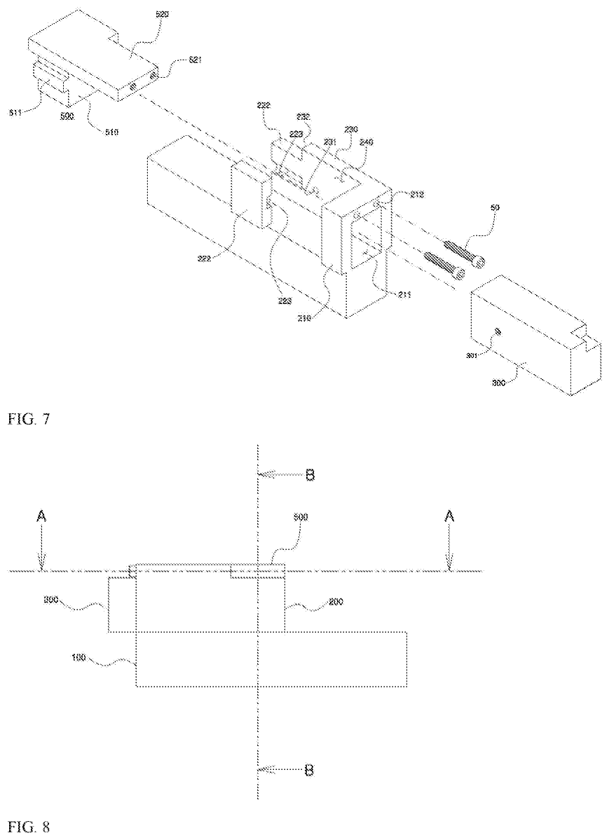

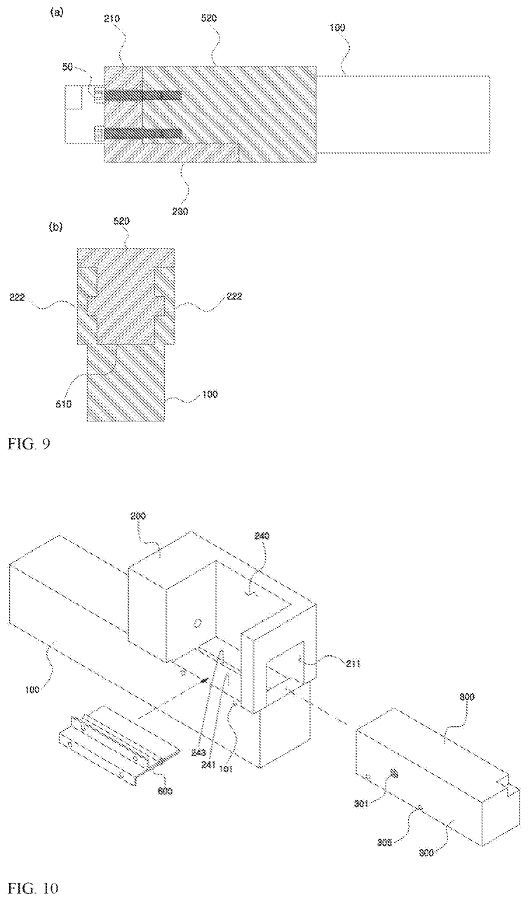

As shown in FIGS. 6, 7, 8 and 9. the rear portion 220 of the tool mount 200 is composed of both guides 222 symmetrically spaced left and right apart from each other, the heights of the guides 222 are the same as the height of the cutting body 300 accommodated in the fastening space 240, the width between the guides 222 is the same as the width of the cutting body 300, and a stepped guide groove 223 is formed on the inner side of each of the guides 222.

The tool holder 10 further includes an assistant stopper 500 having: a connecting portion 510 that has guide taps 511 formed on both sides to correspond to the positions of the guide grooves 223 of the guides 222 and is disposed between the guides 222; and a pressing portion 520 that horizontally extends from a surface of the upper end portion of the connecting portion 510 and comes in close contact with the top of the cutting body 300 accommodated in the fastening space 240 to come in contact with a stepped surface 232 formed between the top of the right side 230 of the tool mount 200 and the top of a first guide 222 connected with the right side 230 when the connecting portion 510 is fitted between the guides 222.

In the tool holder 10 for a cutting insert, a pair of first fastening holes 212 spaced apart from each other is formed over the guide hole 211 formed through the front portion 210 of the tool mount 200 and second fastening holes 521 are formed. in an end of the pressing portion 520 to correspond to the positions of the first fastening holes 212.

First, the rear portion 220 of the tool mount 200 is composed of both guides 222 symmetrically spaced left and right apart from each other, the first guide 222 of the guides 222 is connected with the right side 230, which is a closed side of the fastening space 240, and is stepped to have a height smaller than the height of the right side 230, and a second guide 222 faces the first guide 222, whereby the guides 222 have a left-right symmetric shape.

Describing the shapes of the guides 222 in more detail, the heights of the guides 222 are the same as the height of the cutting body 300 accommodated in the fastening space 240, and the width between the guides 222 is the same as the width of the cutting body 300.

The stepped guide grooves 223 are longitudinally formed on the inner sides of the guides 222 and the guide taps 511 of the assistant stopper 500 described above are fitted therein by sliding. The assistant stopper has an integrated structure composed of the connecting portion 510 and the pressing portion 520, and when the connecting portion 510 is fined between the guides 222, the protrusive taps 511 longitudinally formed on both sides are fitted into the guide grooves 223, whereby the guides 222 and the connecting portion 510 are coupled by sliding.

The pressing portion 520 has a shape connected to a surface of the upper end portion of the connecting portion 510 and longitudinally extending. The pressing portion 520 horizontally extending is connected to a surface excluding another surface of the upper end portion of the connecting portion 510 that faces the stepped surface 232 between the right side 230 of the tool mount 200 and the first guide 222. The pressing portion 520 covers and comes in close contact with the top of the cutting body 300 accommodated in the fastening space 240, and the top of the right side 230 of the tool mount 200 and the top of the pressing portion 520 make a plane without a step.

A pair of second fastening holes 521 is formed in the free end of the pressing portion 520 of the assistant stopper 500 to couple and fix the assistant stopper 500 to the tool mount 200, and first fastening hole 212 are formed over the guide hole 211 formed through the front portion 210 of the tool mount 200, which faces the free end of the pressing portion 520, to correspond to the positions of the second fastening hole 521, whereby the assistant stopper 500 and the tool mount 200 are fastened by a fastening bolt 50.

When the cutting body 300 fitted in the fastening space 240 through the guide hole 211 of the tool mount 200 needs to be replaced after being machined, it is difficult to separate the cutting body 300 because it is attached and fixed in the fastening space 240 by melting of a cutting oil, etc., so the tool holder 10 further has the following structure so that the cutting body 300 can be easily separated out of the fastening space 240.

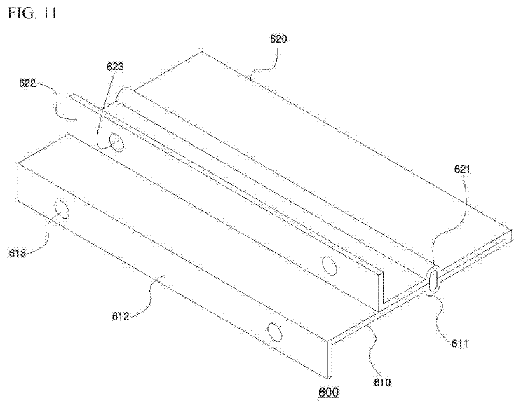

As shown in FIGS. 10 and 11, the bottom 241 of the fastening step 240 is stepped to have a height smaller than the height of the bottom of the guide hole 211 and a locking groove 243 is longitudinally formed at the center of the stepped bottom 241.

The tool holder 10 further includes a separation guide member 600 disposed on the stepped bottom 241 of the fastening space 240 of the tool mount 200 and composed of a lower plate 610 and an upper plate 620. The lower plate 610 has a first elastic portion 611 recessed downward and corresponding to the length of the locking groove 243 to be locked in the locking groove 243 in surface contact with the stepped bottom 241, and a first bending plate 612 having a pair of first fixing holes 613 spaced apart from each other and bending and extending downward from a left end thereof to be fastened and fixed in surface contact with the left side of the holder body 100 under the left side of the tool mount. The upper plate 620 is formed over the lower plate 610, is in close contact with the bottom of the cutting body 300 fitted in the fastening space 240, has a right end connected to the right end of the lower plate 610, has a second elastic portion 621 formed to correspond to the position of the first elastic portion 611 of the lower plate 610 and being convex upward to protrude upward over the locking groove 243, and has a second bending plate 622 having a pair of second fixing holes 623 spaced apart from each other to be fastened and fixed in surface contact with an exposed surface of the cutting body 300 fitted in the fastening space 240, and bending and extending upward from a left end thereof.

The separation guide member 600 has an integrated structure in which the lower plate 610 at the lower portion and the upper plate 620 at the upper portion that are discriminated from each other and having right ends connected to each other, and the left end of the lower plate 610 and the left end of the upper plate 620 are positioned at the right side opposite to the right side 230 of the tool mount 200.

The lower plate 610 is disposed on the stepped bottom 241 of the fastening space 240 with the first elastic portion 611, which is longitudinally formed at the center and concavely protruding downward, inserted in the locking groove 243 of the stepped bottom 241. The first bending plate 612 bends downward from the left end of the left plate 610 and is in surface contact with the left side of the holder body 100 under the left side of the fastening space 240 of the tool mount 200. Third fixing holes 101 are formed in the left side of the holder body 100 under the left side of the tool mount 200 at positions corresponding to the first fixing holes 613 formed through the first bending plate 612. The lower plate 610 is fixed to the holder body 100 by tightening fasteners (not shown) in the first and third fixing holes 613 and 101.

The bottom shape of the locking groove 243 formed on the stepped bottom 241 of the fastening space 240 is the same as the external shape of the first elastic portion 611 and the depth that is the length of the locking groove 243 is smaller than the protrusive length of the first elastic portion 611, so the first elastic portion 611 is closely pressed and fitted in the narrow space of the locking groove 243 while maintaining the elasticity. Accordingly, when the lower plate 610 is separated from the tool mount 200, the lower plate 610 is deformed and separated from the locking groove 243 by the elastic restoring force of the first elastic portion 611 and finely moves the cutting body 300 fitted in the fastening space 240, thereby inducing separation from the fastening space 240.

On the other hand, the locking groove 243 and the first elastic portion 611 may have cross-sectional shapes that maintain a floating state or a surface contact state of the first elastic portion 611. Fine vibration transmitted by cutting is transmitted to the first elastic portion 611 inserted in the locking groove 243 and the first elastic portion 611 continuously transmits a fine wave motion to the lower plate 610 and the upper plate 620, whereby the fastening space 240 and the cutting body 300 keeps separated.

The upper plate 620 is formed over the lower plate 610 and presses the bottom of the cutting body 300 fitted in the fastening space 240. Further, the upper plate 620 has a second elastic portion 621 that is convex upward at a position corresponding to the first elastic portion 611 of the lower plate 610. Accordingly, the upper plate 620 presses the bottom of the cutting body 300 in close contact with the bottom while elastically pressing the portion, which corresponds to the second elastic portion 621, of the bottom of the cutting body 300. Fine vibration is transmitted to the locking groove 243 and the first elastic portion 611 through the second elastic portion 621 during machining by the cutting body 300 while the elasticity of the second elastic portion 621 is maintained, thereby preventing adherence due to a cutting oil between the cutting body 300 and the upper plate 620 and the lower plate 610 of the separation guide member 600.

The left-right width of the upper plate 620 is smaller than the left-right width of the lower plate 610. The second bending plate 622 bending upward from the left end of the upper plate 620 and is in surface contact with the exposed surface of the cutting body 300 fitted in the fastening space 240 of the tool mount 200. that is, the exposed surface of the cutting body 300 at a position corresponding to the open left side of the fastening space 240. Fourth fixing holes 605 are formed in the exposed space of the cutting body 300 at positions corresponding to the second fixing holes 623. The upper plate 620 is fixed to the cutting body 300 by tightening fastening members (not shown) in the second and fourth fixing holes 623 and 305.

The above description merely explains the spirit of the present disclosure and the embodiments may be changed and modified in various ways without departing from the spirit of the present disclosure by those skilled in the art. Accordingly, the embodiments described herein are provided merely not to limit, but to explain the spina of the present disclosure, and the spirit of the present disclosure is not limited by the embodiments. The protective range of the present disclosure should be construed by the following claims and the scope and spirit of the present disclosure should be construed as being included in the patent right of the present disclosure.

What is claimed is:

1. A tool holder for a cutting insert, the tool holder comprising:
a holder body having a predetermined horizontal length; and
a tool mount disposed on an end portion of the holder body to fix a cutting body combined with a cutting insert at a side of a top of a front thereof,
wherein the tool mount has a tetrahedral fastening space positioned between a front portion and a rear portion and has a rectangular internal cross-section with open left side and top, a guide hole connected to the fastening space through the front portion, a first bolt hole formed through a right side and a second bolt hole formed through a center of a front and a center of a rear of the rear portion, and
wherein the cutting body has the same shape as a cross-section of the guide hole of the tool mount, is inserted into the fastening space through the guide hole, and has a third bolt hole and a fourth bolt hole formed at positions respectively corresponding to the first bolt hole and to the second bolt hole.

2. The tool holder of claim 1, wherein a stepped fitting groove is formed on a bottom of the fastening space,
wherein the tool holder further comprises a coupler having a fitting portion having the same shape as a cross-section of the stepped fitting groove, and a coupling portion perpendicularly connected to an outer end of the fitting portion having the same height as a height of the cutting body, a protrusive tap having a regular triangular cross-section on an inner side, and a fifth bolt hole formed therethrough at a position corresponding to the third bolt hole, and
wherein a close-contact groove having the same shape as a cross-section of the protrusive tap of the coupler is formed on a side of the cutting body to closely accommodate the protrusive tap.

3. The tool holder of claim 1, wherein the rear portion of the tool mount is composed of two guides symmetrically spaced left and right apart from each other, wherein heights of the guides are the same as a height of the cutting body accommodated in the fastening space, wherein a width between the guides is the same as a width of the cutting body, wherein a stepped guide groove is formed on an inner side of each of the guides,
wherein the tool holder further comprises an assistant stopper having a connecting portion that has guide taps formed on both sides to correspond to positions of the guide grooves of the guides and is disposed between the guides, and a pressing portion that horizontally extends from a surface of an upper end portion of the connecting portion and comes in close contact with a top of the cutting body accommodated in the fastening space to come in contact with a stepped surface formed between a top of the right side of the tool mount and a top of a first guide connected with the right side when the connecting portion is fitted between the guides, and
wherein a pair of first fastening holes spaced apart from each other is formed over the guide hole formed through the front portion of the tool mount, and second fastening holes are formed in an end of the pressing portion to correspond to positions of the first fastening holes.

4. The tool holder of claim 2, wherein the rear portion of the tool mount is composed of two guides symmetrically spaced left and right apart from each other, wherein heights of the guides are the same as the height of the cutting body accommodated in the fastening space, wherein a width between the guides is the same as a width of the cutting body, wherein a stepped guide groove is formed on an inner side of each of the guides,
wherein the tool holder further comprises an assistant stopper having a connecting portion that has guide taps formed on both sides to correspond to positions of the guide grooves of the guides and is disposed between the guides, and a pressing portion that horizontally extends from a surface of an upper end portion of the connecting portion and comes in dose contact with a top of the cutting body accommodated in the fastening space to come in contact with a stepped surface formed between a top of the right side of the tool mount and a top of a first guide connected with the right side when the connecting portion is fitted between the guides, and
wherein a pair of first fastening holes spaced apart from each other is formed over the guide hole formed through the front portion of the tool mount, and second fastening holes are formed in an end of the pressing portion to correspond to positions of the first fastening holes.

5. The tool holder of claim 1, wherein a bottom of the fastening step is stepped to have a height smaller than a height of a bottom of the guide hole,
wherein a locking groove is longitudinally formed at a center of the stepped bottom,
wherein the tool holder further comprises a separation guide member disposed on the stepped bottom of the fastening space of the tool mount and composed of a lower plate and an upper plate,
wherein the lower plate has a first elastic portion recessed downward and corresponding to a length of the locking groove to be locked in the locking groove in surface contact with the stepped bottom, and a first bending plate having a pair of first fixing holes spaced apart from each other and bending and extending downward from a left end thereof to be fastened and fixed in surface contact with a left side of the holder body under a left side of the tool mount, and
wherein the upper plate is formed over the lower plate, is in close contact with a bottom of the cutting body fitted in the fastening space, has a right end connected to a right end of the lower plate, has a second elastic portion formed to correspond to a position of the first elastic portion of the lower plate and being convex upward to protrude upward over the locking groove, and has a second bending plate having a pair of second fixing holes spaced apart from each other to be fastened and fixed in surface contact with an exposed surface of the cutting body fitted. in the fastening space and bending and extending upward from a left end thereof.

6. The tool holder of claim 2, wherein the bottom of the fastening step is stepped to have a height smaller than a height of a bottom of the guide hole,
wherein a locking groove is longitudinally formed at a center of the stepped bottom,
wherein the tool holder further comprises a separation guide member disposed on the stepped bottom of the fastening space of the tool mount and including a lower plate and an upper plate,
wherein the lower plate has a first elastic portion recessed downward and corresponding to a length of the locking groove to be locked in the locking groove in surface contact with the stepped bottom, and a first bending plate having a pair of first fixing holes spaced apart from each other and bending and extending downward from a left end thereof to be fastened and fixed in surface contact with a left side of the holder body under a left side of the tool mount, and
wherein the upper plate is formed over the lower plate, is in close contact with a bottom of the cutting body fitted in the fastening space, has a right end connected to a right end of the lower plate, has a second elastic portion formed to correspond to a position of the first elastic portion of the lower plate and being convex upward to protrude upward over the locking groove, and has a second bending plate having a pair of second fixing holes spaced apart from each other to be fastened and fixed in surface contact with an exposed surface of the cutting body fitted in the fastening space and bending and extending upward from a left end thereof.
